(19) United States
(12) Patent Application Publication
(10) Pub. No.: US 2002/0059499 A1
(43) Pub. Date: May 16, 2002

(54) System and methods for performing last-element streaming

(76) Inventor: Michael D. Hudson, Portland, OR (US)

Correspondence Address: GERALD B ROSENBERG, NEW TECH LAW, 285 HAMILTON AVE, SUITE 520, PALO ALTO, CA, 94301, US

(21) Appl. No.: 09/947,048

(22) Filed: Sep. 5, 2001

Related U.S. Application Data
(60) Provisional application No. 60/230,348, filed on Sep. 6, 2000.

(51) Int. Cl. G06F 12/00

(52) U.S. Cl. 711/118; 709/217

(57) ABSTRACT

A network system supporting the streaming of multimedia content provided from a server system through a network connection to a content player executed by a client system. The network system includes a last-element cache provided as the terminal element of a distributed network cache system, where the last-element cache resides within a persistent data store of a client system, and a cache content controller, coupled to the last-element cache, that operates as the exclusive local access manager for the content of the last-element cache. The cache content controller is responsive to information provided by a remote content server system to select a plurality of predetermined content files for storage by the last-element cache. The cache content controller is also responsive to requests by the content player to select a predetermined one of the predetermined content files for streaming transfer to the content player.

### CROSS-REFERENCE TO RELATED APPLICATIONS

The present application is related to the following Application, assigned to the Assignee of the present Application, and is incorporated herein by reference:

1) Client-side Last-Element Cache Network Architecture, Hudson et al., SC/Ser. No.______, filed concurrently herewith.

### BACKGROUND OF THE INVENTION

1Field of the Invention

The present invention is generally related to streaming data delivery systems and, in particular, to a system architecture and methods providing for the streaming delivery of multimedia information through use of a secure content last-element cache.

2. Description of the Related Art

Throughout the development and growth of the Internet, there has been substantial interest and repeated efforts to support real-time streaming of multimedia data on-demand over the Internet to client users. The multimedia data involved in these efforts have included variously licensed and unlicenced multimedia audio and video content. While interest remains high, conventional efforts to date have been largely unsatisfactory in their ability to reliably deliver high-quality content over the Internet.

There are numerous, well-recognized problems in the streamed delivery of multimedia content over any public communications network, such as the Internet. Since the delivery of streamed content is preferably performed on-demand, the server systems used to source the content must have the capacity, performance capabilities, and network connectivity to handle all reasonable peak demands for content. The capital cost and management burden for maintaining server systems capable of handling such substantial peak demands is conventionally recognized as being nearly prohibitive in all but exceptional circumstances.

Another fundamental problem arises from the nature of the Internet itself. Since content delivery almost always involves transfers through multiple network provider domains, ensuring reliable content routing and adequate delivery bandwidth is almost impossible. There are simply no reliable source controls over the rate and consistency of delivery of streaming content through multiple Internet domains to widely distributed client content players. While conventional players can and often do implement stream buffers as a means of masking delivery rate variations, such buffering is quite often insufficient to preclude noticeable if not extended interruptions in the streaming content as played. The creation of larger buffers is typically precluded by the limited bandwidth connection to the client player from the Internet in the first instance and the corresponding long startup times required to buffer significant amounts of the content stream. Although bulk downloading of the streaming content is possible, the necessarily resulting substantial delay in completing the download effectively defeats the ability to provide on-demand services.

Both bulk downloading and on-demand streaming content distribution systems are also subject to significant problems arising from the need for centralized and verifiable control over licensed content. Although fundamentally capable digital rights management systems (DRMs) have been established, the management and convenient use of distributed digital content licenses by and for end-users remain problematic. Content distributers conventionally appear to prefer providing their content subject to licenses in a streamed format, rather than as individual bulk downloads. Thus, while end-user licenses may be persistently distributed, the actual content is preferably provided on-demand or not at all. As a result, there is a fundamental tension between providing on-demand delivery of streaming multimedia content and ensuring a reliably continuous, high-quality streamed content experience to end-users. This tension has simply not been solved as a practical matter by any conventional streaming content delivery system.

One conventional approach to improving the reliably continuous delivery of streaming content relies on the distribution of specialized content caches throughout the network infrastructure. Deployed at the edges of the network infrastructure domains maintained by major network service providers, as typified by Inktomi Corporation, Foster City, Calif., network edge caches can be preferentially loaded and managed to hold and source selected content at network locations that are at least logically closer to any end-users who requests the cached contents. Network edge caches can be effective in reducing much of the peaking demand from the content source server systems for repeatedly requested content. The amount of the benefit actually realized, however, is highly dependent on the number, size, and distribution of the network edge caches. Thus, the costs involved in necessarily deploying many significantly sized network edge caches over very wide geographic regions, if not world-wide, can be substantial. The costs can in fact be prohibitive where the content consists of many multi-megabyte files, which is typical of multimedia content.

Even with a wide distribution of network edge caches, however, the caches cannot solve the fundamental problems of content delivery variability between any closest network edge cache and a content requesting end-user. The provision and use of network edge caches also cannot improve any inherent bandwidth limitations that may exist between the cache and client system. Thus, while a network edge cache system can mask the sensitivity of streaming content delivery to network bandwidth variations that may occur within a cached domain, such systems ultimately fail to ensure that streaming content can be reliably and continuously delivered to an end-user client system.

Consequently, there remains a clear need and substantial desire for a system capable of securely delivering multimedia content to the desktop while presenting end-users with on-demand streaming content in a high-quality, reliably continuous form.

### SUMMARY OF THE INVENTION

Thus, a general purpose of the present invention is to provide a system and method for performing last-element streaming to ensure the secure, on-demand streaming of multimedia content in a high-quality, reliably continuous form.

This is achieved in the present invention by providing a network system that supports the streaming of multimedia content provided from a server system through a network connection to a content player executed by a client system. The network system includes a last-element cache provided as the terminal element of a distributed network cache system, where the last-element cache resides within a persistent data store of a client system, and a cache content controller, coupled to the last-element cache, that operates as the exclusive local access manager for the content of the last-element cache. The cache content controller is responsive to information provided by a remote content server system to select a plurality of predetermined content files for storage by the last-element cache. The cache content controller is also responsive to requests by the content player to select a predetermined one of the predetermined content files for streaming transfer to the content player.

An advantage of the present invention is that the last-element cache is local to and persistently stored on the client system. All content that is streamed from the last-element cache to the content player is through a stream port and data transfer path that is entirely local to the client system. As a result, for content sourced from the last-element cache, the content stream rendered by the content player is reliably continuous and at the full available bit-rate quality of the source content.

Another advantage of the present invention is that the last-element cache is managed through the effectively centralized operation of a remote server system. Identifications and sources of available content for transfer into the last-element cache are collectively managed by the remote server system. Control files selectively containing this information are dynamically generated and made available to client systems hosting last-element caches. The remote server system can also use the control files to specify, preferably by providing action times or time windows, when a cache content controller is to retrieve particular content, thereby allowing the remote server system to effectively manage and optimally distribute the aggregate content transfer load of the participating client system across any set of content serving resources.

A further advantage of the present invention is that the cache content controller is capable of autonomous evaluation of retrieved control files, to suitably implement content transfers to the last-element cache subject to defined rules of operation and conditioned on preferences and feedback collected through interaction with a local end-user, thereby permitting personalization of the content retrieved into the last-element cache of a particular client system and of the content streamed to the local content player.

Still another advantage of the present invention is that the cache content controller operates as the exclusive local access manager with regard to the last-element cache. A network access proxy is established by the cache content controller to enable transparent interception of network requests made by the content player, thereby enabling selected requests to be redirected through the cache content controller and satisfied from the last-element cache. Thus, the storage and retrieval of content files from the last-element cache can be uniquely handled by the cache content controller.

Yet another advantage of the present invention is that the access to and use of each last-element cache can be individually secured by license using a client DRM system supported by the associated client system. By requiring validation of access by the cache content controller to the last-element cache, the entire last-element cache can be maintained secure through the associated encryption mechanisms of the DRM system. Furthermore, content files stored within the last-element cache may be also independently licensed through the DRM system. Each licensed content file is therefore retrieved and stored into the last-element cache in an encrypted form that is not resolved until after the content file is streamed to the content player, which independently implements a license authentication interaction with the DRM system. Such independent encryption of the content files is entirely transparent to the operation of the cache content controller.

Still another advantage of the present invention is that any information used or collected by the cache content controller, including control files and feedback information, may be securely stored and retrieved, as needed, from the last-element cache. Since all accesses of the last-element cache are subject to DRM validation, such information can be securely stored within the last-element cache, thereby precluding tampering or other violation of the correct operation of the cache content controller.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1 provides a block diagram of a network system implementing a last-element streaming cache system in accordance with a preferred embodiment of the present invention;

FIG. 2 provides a detailed block diagram of an implementation of a server-side system suitable for supporting content delivery to a last-element streaming cache system in accordance with a preferred embodiment of the present invention;

FIG. 3 provides a detailed block diagram of a client-side system implementing a last-element streaming cache system in accordance with a preferred embodiment of the present invention;

FIG. 4 provides a process flow describing the preferred method of installing a last-element streaming cache system in accordance with a preferred embodiment of the present invention;

FIG. 5 provides a process flow of the initial startup procedures implemented by a last-element streaming cache system in accordance with a preferred embodiment of the present invention;

FIG. 6 provides a process flow of the top-level run-time operation of a last-element streaming cache system in accordance with a preferred embodiment of the present invention;

FIG. 7 provides a process flow of the channel data streaming and operation and related control of a last-element streaming cache system in accordance with a preferred embodiment of the present invention; and

FIG. 8 provides a process flow showing the responsive operation of a server-side system to requests by a last-element streaming cache system in accordance with a preferred embodiment of the present invention.

### DETAILED DESCRIPTION OF THE INVENTION

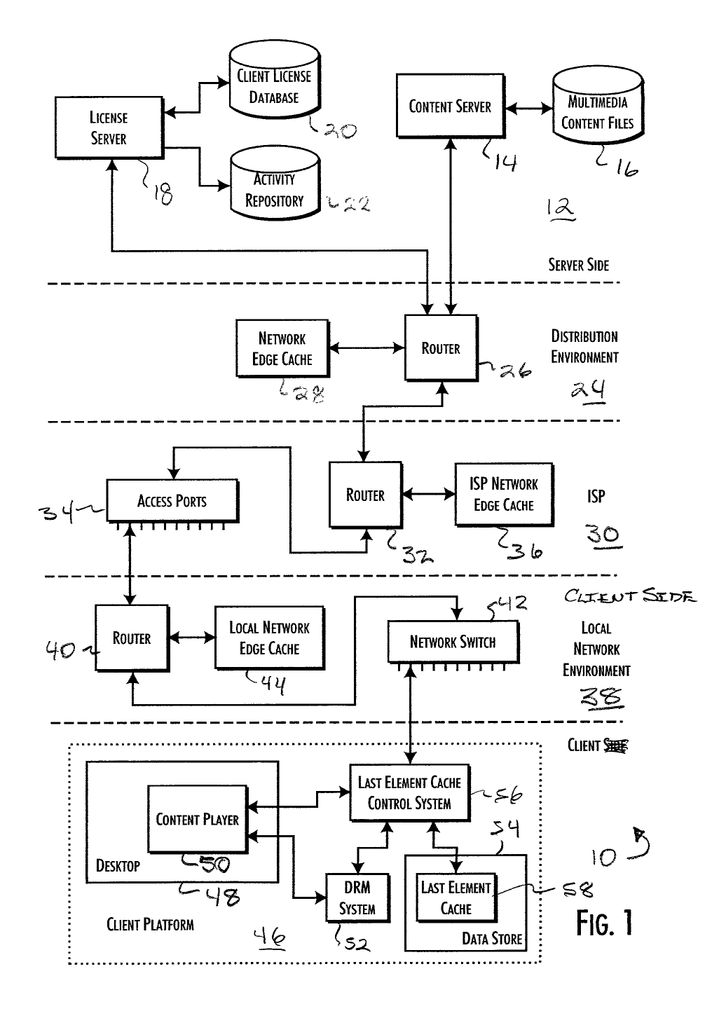

The system implementation of the present invention is essentially independent of the varied network infrastructure components and systems that route connections between server systems, operated as a centralized source of multimedia content, and the client systems where the content is played. As generally represented in the network diagram 10 of FIG. 1, server systems, logically deployed in a server-side layer 12, typically include a content server 14 managing a multimedia content files database 16 and a license server 18, including a client license database 20 and license activity information repository 22, that is responsible for independently supporting the secure use of the stored content files. These server systems 14, 18 connect through a network distribution environment 24, typically representing the domain of one or more primary internet service providers (ISPs) and providing backbone Internet transport. The distribution environment 24 may selectively divert content request connections, managed through a high-performance router 26, to selectively satisfy frequent requests for content from a network edge cache 28. Conventionally, a network edge cache 28 is provided to reduce the cross-domain traffic load and latency of selected content transfers for the internal operating benefit of the distribution environment 24. The content of the network edge cache 28 is largely determined by the relative frequency and transfer size of the network requests processed by the router 26. Management of the cache contents is possible, but particularly difficult where the cached data is large and highly dynamic, as is typical in the case of ever-changing popular multimedia content. Cache content management on behalf of third-parties, such as independent content sources, is also cost intensive to provide and difficult to manage, given that cache contents must be distributed across the many primary domains with geographically distributed infrastructure centers and quite varied integration requirements. The value of edge cache content management by or on behalf of third-party content providers is therefore only conventionally realized where the content under management is well-defined, centrally controlled particularly in terms of size and type, and relatively static over time periods typically measured in weeks or months.

A downstream or terminal ISP domain 30, representing the Internet connection agent for any particular client system, typically implements a router 32 and access ports 34, along with any necessary and desirable hosting infrastructure, to support client connectivity to the distribution environment 24. The additional infrastructure may include an ISP network edge cache 36, similar in function to the network edge cache 28. Although the ISP 30 and primary domain ISP of the distribution environment 24 may be the some entity, typically the ISPs are different and independent. Consequently, the relationship of cache contents held by any ISP network edge cache 36 and the operation of any particular content server 14 is further removed and conventionally considered more difficult if not impossible, as a practical matter, to centrally manage.

In larger organizational settings, a client-side, local network environment 38 may include a locally routed network, including routers 40, network distribution switches 42, and local network edge caches 44. As with the network edge cache 28, a local network edge cache 44 primarily serves to satisfy selected network requests otherwise routeable outside of the local domain and thereby reduce common traffic with the upstream ISP 30. Since the local network edge caches 44 are locally maintained and operated, there are very limited and diffuse opportunities to support remote management of the local edge cache 44 contents by any of the likely many remote content servers 14.

Finally, the local network environment 38 includes any number of client platforms 46, which are typically personal computers capable of executing a client operating system and application programs and of persisting data files on a compatible file system. A client platform 46 connects through the network switch and router 40 of the local network environment 38 or directly to an available access port 34 provided by the ISP 30. For the preferred embodiments of the present invention, the client platform 46 is a personal computer executing a Microsoft Corporation operating system, such as Windows® ME or Windows® 2000, which supports a graphical desktop program execution environment 48, a media player 50, such as the Windows® Media Player, version 7, and one or more client-side License Compliant Module (LCM) software components, which implement a client-side digital rights management (DRM) system 52 consistent with industry standards, and in particular the Secure Digital Music Initiative (SDMI; www.sdmi.org). A number of companies are currently providing DRMs of various capabilities, including lntertrust Technologies Corp. (Santa Clara, Calif.; www.intertrust.com), Microsoft Corporation (Redmond, Wash.; www.microsoft.com), SealedMedia, Inc. (San Francisco, Calif.; www.sealedmedia.com), and Preview Systems, Inc. (Sunnyvale, Calif.; www.portsoft.com). The operating system, in conjunction with the hardware of the client platform 46 preferably provides or through appropriate connectivity, such as a conventional or wireless network connection, supports a file system on a persistent data storage device 54, typically a conventional hard disk drive, for storing data within a general file access framework implemented by the operating system.

In accordance with the present invention, a last-element cache control system 56 is provided within the execution environment of the client platform 46 and a persistent last-element cache 58 is provided in the data store 58. The last-element cache control system 56 preferably operates as a proxy interface to the network on behalf of the content player 50, implements a management and access control layer over the services provided by the file system of the underlying operating system with respect to the last-element cache 58, and interoperates with the DRM system 52. That is, the last-element cache 58 is preferably maintained as essentially a single file or file system object encoded consistent with the licensing and encryption/decryption services provided by the DRM system 52. The cache control system 56 is preferably unique in performing the internal storage management functions necessary to organize, store, and retrieve content from within the last-element cache 58, though subject to having an appropriate DRM license corresponding to the last-element cache 58.

Preferably, cache access requests can be either specifically directed to the cache control system 56 or intercepted by the proxy element of the cache control system 56. Specifically, access requests received from the content player 50 can be selectively satisfied by the cache control system 56 by supporting the streaming transfer of content from the last-element cache 58 through a streaming port connection from the proxy of the cache control system 56 and the content player 50. The selection of content streamed may be specified by the content player 50 or, as in the preferred embodiments of the present invention, autonomously determined by the cache control system 56 based on control and rules files provided by or though the content server 14 and the available content as may then be stored by the last-element cache 58.

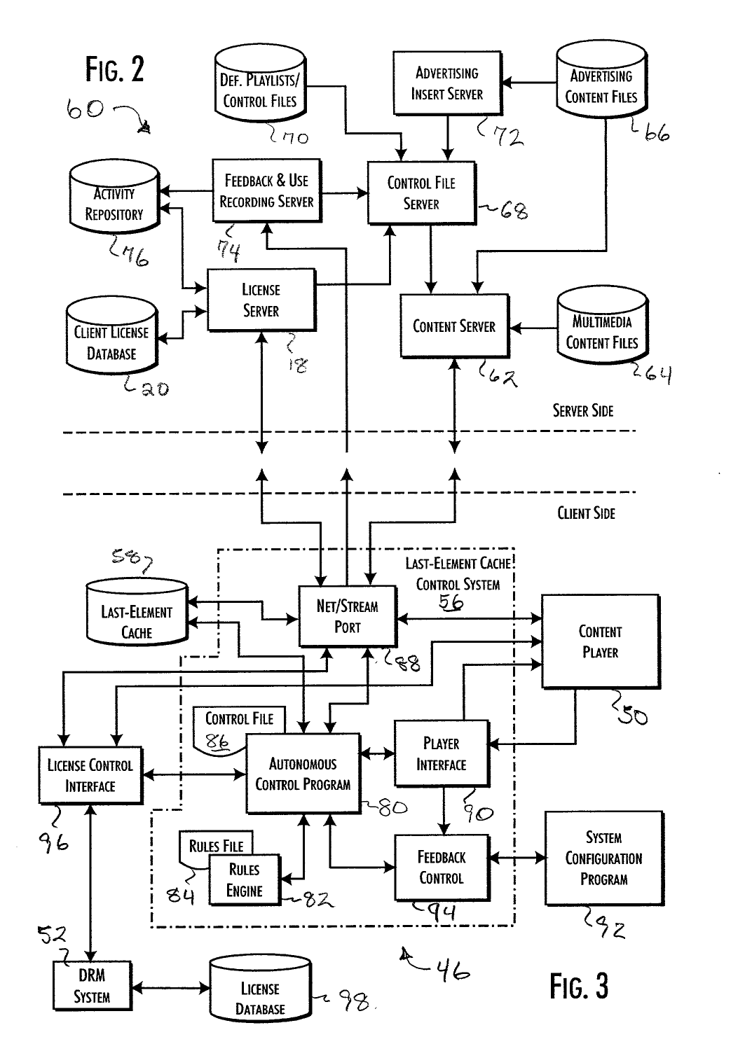

As generally shown in FIG. 2, a content server system 60 in accordance with the system architecture of the present invention, is preferably a logically associated complex of servers interoperating to support the remote retrieval of content, develop and support the retrieval of control files, and provide centralized server-side DRM support. For the preferred embodiments of the present invention, a content server 62 is provided to enable the retrieval of licensed and unlicenced multimedia content files 64 and advertising related content files 66. The content server 62 also enables the retrieval of control files as developed and provided by a control file server 68.

For the preferred embodiments of the present invention, the control file server 68 operates to organize the available multimedia content into a variety of distinctive programming content channels analogous to multiple radio broadcasts serving different market demographics, such as top 40, jazz, and rock & roll. The channel format framework, identifications of other available content servers, which may be the preferred source of particular multimedia content, times when particular content is available, the geographic locations and aggregate bandwidth limits of particular content servers 62, and other basic data is preferably provided from a database 70 of basic control files and templates. Advertising inserts, promotions, and other sponsored content are preferably organized and provided by an advertizing insert server 72 to the control file server 68. New content and new advertisements, promotions and other inserts are identified and thus effectively made available to the control file and advertising insert servers 68, 72 by updating the basic control files and templates held by the database 70. Consequently, through appropriate replication of the contents of the database 70 between distributed content server systems 60, management of the contents of the many last-element caches 58 and the distribution of content retrieval loads imposed by the client platforms 46 can be centrally maintained and organized.

Other information, relating statistical use, explicit preferences, including end-user qualified retrieval windows, and end-user interest feedback related to the content provided to client platforms 46, is preferably received periodically and recorded by a feedback and use recording server 74 to an activity repository 76. This reported use information is also subsequently provided on-demand to the control file server 68. Thus, when any particular client platform 46 requests an updated control file, the control file server 68 preferably responds by dynamically generating a responsive updated control file based in various parts on the content channels referenced in the update request, the last control file or files retrieved by the client platform 46, the client platform 46 specific and aggregated feedback information previously recorded, and the multimedia and advertising content files that are available from this or another content server system 60. The resulting updated control file, as dynamically generated, can thus be made as personalized to a specific client platform 46 and end-user as desired, both for the esthetic enjoyment purposes relative to the end-user and to strategically distribute the content request load imposed by the specific client platform 46 temporally across the appropriately corresponding content servers 62. That is, the control file server 68, based in part on the preferred update and content retrieval windows reported by cache control systems 56, can provide specifications within the control files of when and where particular content is preferred to be retrieved.

The last-element cache control system 56 and associated components as implemented on a client platform 46 is shown in greater detail in FIG. 3. In the preferred embodiments of the present invention, an autonomous control program 80 is provided as the central element of the cache control system 56. The autonomous control program 80 continuously interoperates with a rules engine 82 to define the operational state of the cache control system 56 in response to various inputs and operating conditions. A rules file 84, preferably implemented as a state-transition script, is used to configure the operation of the rules engine and thus effect much of the fundamental behavior of the autonomous control program 80. Preferably, part of this behavior is the parsing evaluation of a control file 86 to determine the major activities of the autonomous control program 80. Alternately and as initially implemented in the preferred embodiments of the present invention, the rules file is hard coded into the state transition operation of the rules engine 82.

A control file, in accordance with a preferred embodiment of the present invention, includes multiple sections, each containing parseable directives, that provide a control file identifier, define directly or implicitly a preferred control file update schedule, a recommended priority listing of the content server systems 60 that can be used by the client platform 46, playlists for subscribed content channels, and various meta-directives identifying other retrievable control files as well as default and preferred content server system sources for categorical types and specific instances of content. The update schedule may be implemented logically as an annotation of the ordered list of available content server systems 60 indicating the preferred and allowable time windows usable by the cache control system 56 to retrieve updated control files and additional content.

In the simplest case, a channel playlist is preferably a linearly ordered list of the content files, multimedia, advertising, and other content that are to be streamed to the content player 50 when the corresponding program channel is selected. A channel playlist may also include directives or meta-directives indicating alternative selections of content that may be substituted under varying circumstances. Meta-directives are preferably also used in the control files to specify the logical inclusion of additional control files, for example, to extend or provide alternate channel playlists and to specify source servers from which specific types or instances of content are to be retrieved. Consequently, the autonomous control program 80 is capable of a wide degree of operational flexibility based on the directives provided in control files 86 and, further, can be behaviorally modified and extended by suitable changes made to the rules file 84.

The cache control system 56 includes a network proxy 88 to the external network connected to the client platform 46 and a player interface 90 that supports interoperation with the content player 50 with the cache control system 56. In the preferred embodiments of the present invention, the network proxy 88 is implemented as a transparent intercept for network communications to and from the client platform 46. Nominally, all network requests are passed by the network proxy 88. Requests made by the content player 50 for content from a content server system 60, or other predefined network content source, can be intercepted and redirected, as determined by the autonomous control program 80, through the network proxy for satisfaction from the last-element cache 58. That is, the cache control system 56 initiates a stream data read of the corresponding content from the last-element cache 58 through a network stream port implemented by the network proxy 88 and connected to the content player 50. The content player 50 thus receives the requested stream data in a manner logically indistinguishable from a conventional network data stream, though with certainty that the stream data will be received without interruption and at the full data rate of the requested content, since the functional stream data path is local to the client platform 46. In the preferred embodiments of the present invention, a pseudo-domain can be explicitly associated by the cache control system 56 with the contents of the last-element cache 58. Requests by the content player 50 that reference this pseudo-domain are automatically directed through the network proxy 88 to the last-element cache 58.

The player interface 90 is provided to connect the various content player controls as inputs to the autonomous control program 80. This allows the autonomous control program 80 to transparently intercede in the operation of the content player 50 and provide for the selection and streaming of content from the last-element cache 58. Where the selected content identified by the control inputs from the content player 50 is outside of the scope of the content managed by the cache control system 56, the content request is simply passed by the network proxy 88 to the external network connection. The content player controls are then supported to work as conventionally expected.

In the preferred embodiments of the present invention, where a channel playlist is used to determine the selection and order of content streamed to the content player 50, the player interface 90 supports the channel selection and specific channel operation controls, including the start, stop, pause, and next track controls. Selection of specific playlist identified content, either explicitly or by repeat playing of the content through use of the previous track control, is not supported. Rather, the operation of the autonomous control program 80 is defined through the specification of the rules file 84 to base content selection on the applicable channel playlist and to refine the attributes of the selected playlist, such as through the selection of alternate content and to enforce a minimum frequency that any particular playlist identified content can be streamed to the content player 50. The rules file 84 is thus used to define and enforce playlist handling consistent with licensing requirements as may be generally or specifically associated with the content. In particular, the rules file 84 is preferably constructed to ensure that playlist content is played within the legal requirements necessary for the channel streams managed by the cache control system 56 to qualify as digital transmissions under the provisions of §§114, 115 of Title 17 of the United States Code, as further defined by the Digital Millennium CopyrightAct (DMCA) of 1998, and thereby qualify for the compulsory licensing provisions for digital transmissions.

In addition to the playlist controlled content, other licensed content can be stored in the last-element cache 58. The rules file 86 can provide for the recognition of licensed content otherwise conventionally requested and streamed to the content player 50. An image of such other content can be copied to the last-element cache 58 when initially retrieved through the conventional operation of the content player 50. Subsequent requests for the streaming retrieval of the content by the content player 50 can be intercepted by the network proxy 88 and effectively redirected by the autonomous control program 80 to the image copy present in the last-element cache 58.

A cache control system configuration program 92 is preferably utilized to capture the explicit preferences of an end-user of the content player 50. Implicit preferences are also preferably identified through recognition of explicit control actions and possibly patterns of actions intercepted by the player interface 90. These preferences are provided to a feedback control subsystem 94 of the cache control system 56. The collected explicit preferences preferably include end-user selected frequency, timing, and priority of control file and content updates, channel category interests, and other similar information. Implicit preferences are preferably collected by the feedback control 94 by recognizing end-user actions with regard to specific content, such as activation of the next track control when the content is played. The collected explicit and implicit preferences are preferably stored into the last-element cache 58 by operation of the autonomous control program 80 and subsequently forwarded in connection with a control file update request to a feedback and use recording server 74. Locally, the implicit preferences can also be subjected to interpretation by the autonomous control program 80, ultimately based on the specification of the rules file 84, to select alternate content from playlists in place of content repeatedly skipped. The selection of such alternate content and potentially even alternate channel playlists may be also influenced by the explicit preferences provided by the end-user.

The cache control system 56 preferably interacts with the DRM system 52 through an operating system supported license control interface 96. Direct interactions by the cache control system 56 are supported to enable authenticated access to the last-element cache 58 based on a conventional DRM license managed by the DRM system 52 and stored by a conventional DRM license database 98. Through use of the services of the DRM system 52, the cache control system 56 can maintain the entire last-element cache 58 as an encrypted file system object. In the preferred embodiment of the present invention, the last-element cache 58 appears on the local file system is a single, encrypted file. All data stored within the last-element cache 58, including persistent copies of the rules and control files 84, 86, preferences from the feedback control 94, playlist content, and other content, are stored encrypted based on the DRM license for the last-element cache 58. Even content received through the network proxy 88 in encrypted form is further encrypted using the DRM license for the last-element cache 58. While DRM encryption and licensing protocols are conventionally considered secure, if not highly secure, such double encryption under independent licenses ensures that any individually licensed content stored in the last-element cache 58 is secure.

Consistent with normal operation of conventional content players 50, access to the license control interface through, as necessary, the cache control system 56 is supported. This allows licensed content, decrypted once under the DRM license of the last-element cache 56, to be finally decrypted under the DRM license applicable to the specific content as streamed to the content player 50. Where the content license must be obtained remotely from a license server 18, the network proxy 88 also supports routing of the corresponding network requests to the external network connection.

The preferred process flow 100 for installation of the cache control system 56 is shown in FIG. 4. Using a conventional installation management program, the cache control system 56 programs and files are installed 102, including the installation 104 of default rules and control files 84, 86. The network proxy 88 is then configured 106 into the network stack implemented by the underlying operating system.

A conventional file system search is then performed to locate and identify 108 any and all content players 50 supported in connection with the operation of the cache control system 56. The end-user is preferably permitted to select 110 a content player 50 for use with the cache control system 56. Once a suitable content player 50 is selected, the player interface 90 is linked 112 to the selected content player 50. The cache control system is then started 114 and the user configuration program 92 is run 116. Once basic configuration information is provided by the end-user, such as an allowed size of the lost-element cache 58 and whether network connections on behalf of the cache control system are to be manually or automatically established, an initial transaction with a content server system 60 is initiated to retrieve 118 at least an initial updated control file 86, and to license the installed last-element cache 58 to the user and client platform 46 in accordance with the applicable DRM licensing protocols. Based on the initial updated control file, connections with control file identified content server systems 60 are established and any additional control files are retrieved. Also, based on the retrieved control files, an initial set of content files are retrieved 120 and stored in the last-element cache 58. In general, the retrieval of these control and content files is consistent with the subsequent, normal operational updating of the cache control system 56.

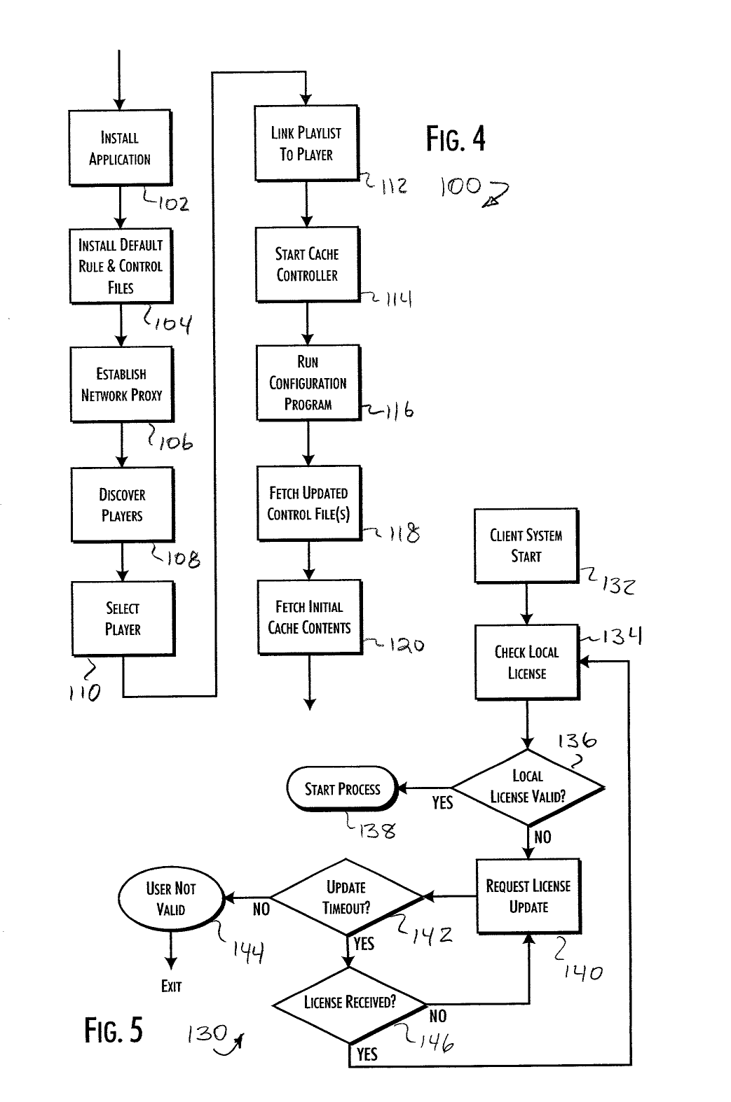

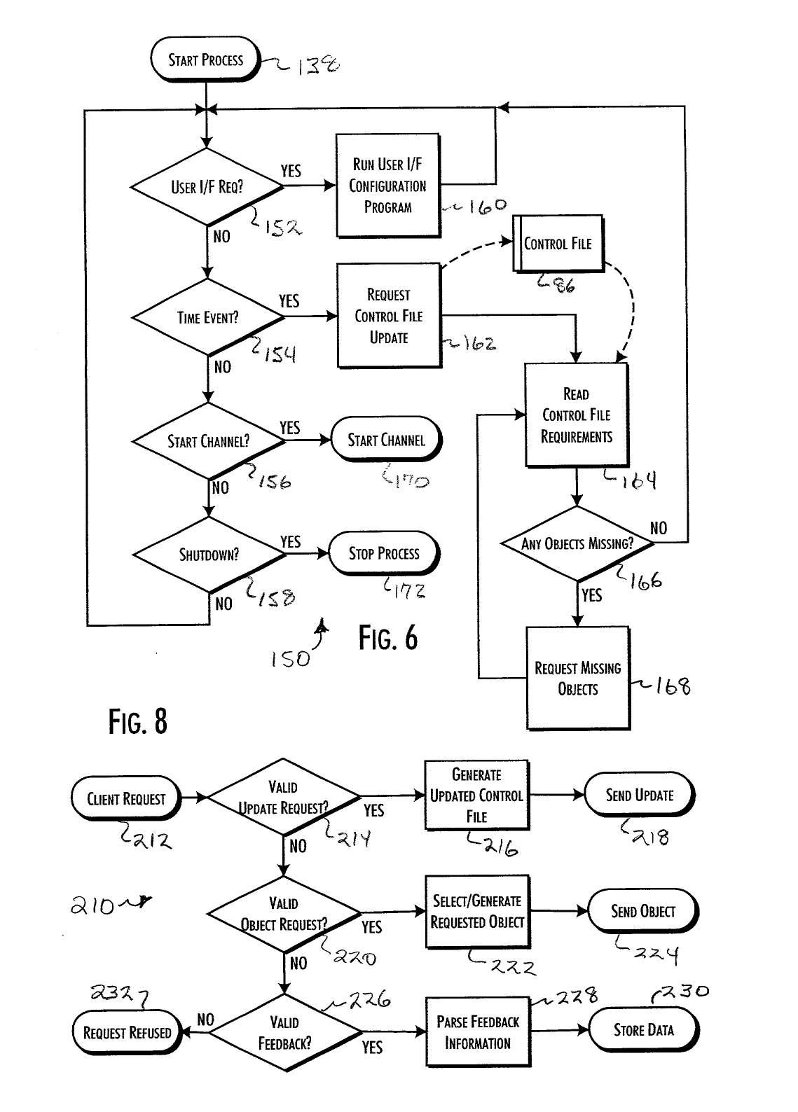

FIG. 5 details the startup execution process 130 as implemented in a preferred embodiment of the present invention. Preferably, execution of the cache control system 56 is initiated with the startup 132 of the client platform 46. On startup, the DRM license for the last-element cache 58 is initially checked 134 to determine validity 136 as necessary to enable access to the last-element cache 58. If the license is valid, the main process of the cache control system 56 is started 138. If the license is determined to be invalid, as may be due to the expiration of the license, an updated license is requested 140 from an applicable license server 18. If an updated license is not timely received 142 or the request is refused, the end-user/client platform is considered not valid 144 and the cache control system 56 terminates, precluding further access to the last-element cache 58 at least until a valid license can be obtained. Finally, where an updated license is received 146, the startup process flow continues by rechecking the license 134 and, as appropriate, starting the main process 138.

The preferred process flow 150 for the main process 138 is shown in FIG. 6. The primary operations of the main loop, which preferably can be defined or altered based on the rules file 84, include determining whether to start 152 the user configuration program 92, whether a timed event 154 defined by a control file has occurred, whether a request to start 156 a playlist channel has been made by the end-user or other local program, and whether a shutdown request 158 has been received. Preferably, the response to a configuration program 92 start request is to invoke 160 the configuration program 92 in a separate thread or process as appropriate and supported by the underlying operating system to avoid blocking execution of the main loop.

The occurrence of a timed event 154 is preferably handled by the creation of a separate process or thread that, in turn, parses the current control file to determine the action to be taken. Typically, the action involves retrieval of an updated control file or some particular content. To ensure that the most current sources of content are used, an updated control 86 may be first requested. In general, an updated control file 86 will be provided by a control file server 68 in response to any valid control file update request 162. The now current control file 86 is then read 164 to identify any present actions to be taken. In general, all objects referenced in the control file, such as other included control files and content, are checked 166 for existence in the last-element cache 58. Each missing object is then retrieved from a control file designated or default content or control file server 62, 68. To allow for the recursive retrieval of control files 86, the current control file 68 and any newly retrieved control files 68 are reread 164 and checked 166 for references to missing objects.

Objects designated within the control file 68 for deferred retrieval are skipped until a timed event 154 occurs within the time window specified for the retrieval action. Timed events are set and, as appropriate, reset each time a parsing of the current control file encounters a deferred retrieval directive. Once all objects identified in the current control file for present retrieval have been retrieved, the current timed event thread or process is terminated.

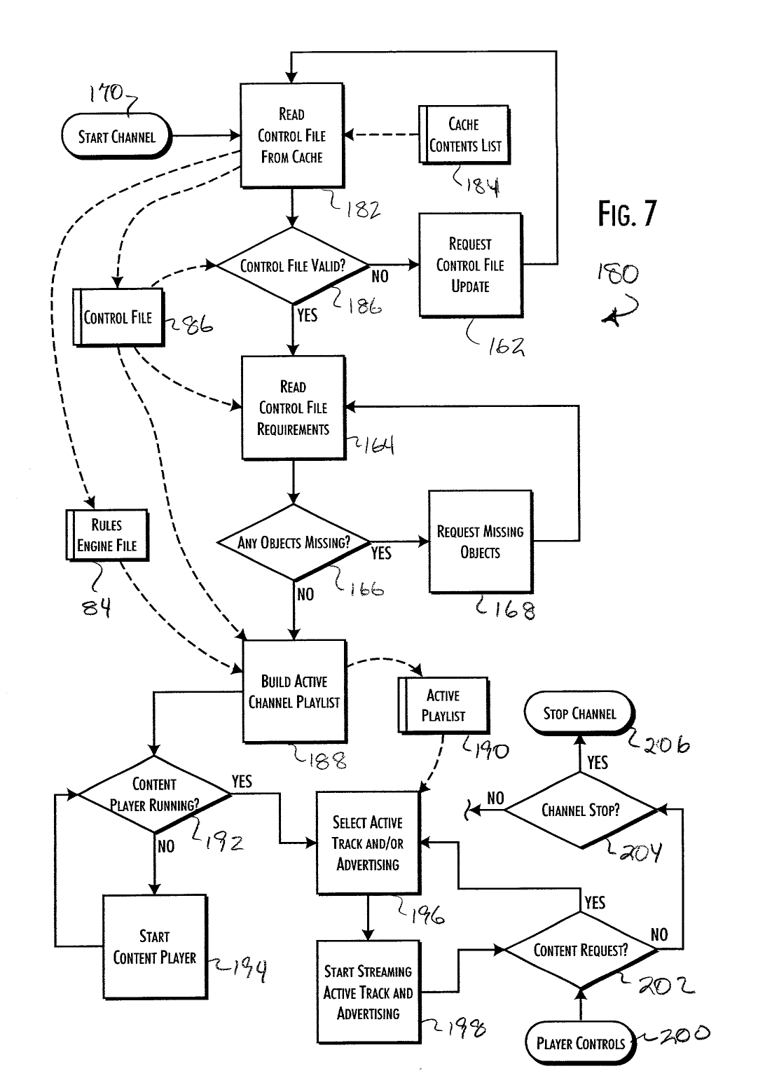

When a start channel event is received 156, a new process or thread is created within which to start 170 channel operations. A channel processing flow 180, consistent with a preferred embodiment of the present invention, is detailed in FIG. 7. Following from a start channel 170 event, the current control file, if not currently in memory, and a list of the current contents of the last-element cache 86 is read 184 from the last-element cache 86. The control file 86 is checked for validity, specifically including whether the current control file has expired and, if not, whether the control file includes a playlist for the currently selected content channel. If the control file is determined to be not valid for some reason 186, an updated control file is requested 162 and the retrieved control file is again read 182 and evaluated for validity 186.

Once a valid control file obtained, the control file is parsed 164 to determine whether the objects referenced by the control file 86 are available in the last-element cache 86. Missing objects, not subject to a deferral directive, are requested 168. To avoid delay in initiating the streaming of channel content, the retrieval of missing objects 168 is preferably executed as a background task, allowing the channel processing flow 180 to continue.

Based on the rules engine file 84 specifications and the current control files 86, the autonomous control program 80 constructs 188 an active channel playlist 190. Preferably, the appropriate channel playlist section of the control files 86 is evaluated against user preferences and feedback information, as well as the currently available content in the last-element cache to select between default and alternative content in constructing 188 the active playlist 190. This evaluation can also be used to, in effect at least, annotate the current control files 86 and thereby affect the retrieval prioritization of missing objects. The annotation may also be used to cancel the retrieval of selected content objects 168 that, as a result of the evaluation, will not be included in any active playlist 190.

The autonomous control program 80 then checks 192 whether the content player 50 is currently running. If the content player 50 is not running, the content player 50 is started in a separate process 194. Once started, the initial content elements of the active playlist 190 are selected 196 and setup to be streamed from the last-element cache 58 to the content player 50 through the cache control system 56. The content player 50 is then provided with the corresponding content request and prompted to issue the request 198 through the player interface 90. The content player 50 and relevant content player controls 200 are then monitored 202 for content requests. In particular, when the content player 50 completes the streaming of some particular content, a next track request is automatically generated by the content player 50. A next track request can also originate from the corresponding player control 200. In both cases, the player interface 90 recognizes the request and initiates the selection 196 and streaming setup 198 of the next track of content as determined from the active playlist 190.

Preferably, a content player pause control is handled internally to the content player 50. The player controls 200, however, are preferably examined 204 to explicitly identify stop commands, which result in the termination 206 of the current channel processing flow 180. Other player controls 200, such as a play previous track command, are preferably ignored.

Referring again to FIG. 6, a preferably last event checked 158 in the main process flow 150 main loop is a shutdown event. In response to the detection 158 of a shutdown event, the memory resources of the cache control system 56 are released and the DRM system 52 notified of the application termination relative to the license to the last-element cache 58. The main process flow 150 is then terminated 172. This results in the termination of the execution of the cache control system 56 and precludes access to the content of the last-element cache 58 at least until the cache control system 56 is restarted.

The preferred process flow 210 implemented by a content server 62 and control file server 68 is generally shown in FIG. 8. When a client request is received 212, the request is first checked 214 to determine if the request is a valid request for an update control file 86. A valid control file update request is processed by the control file server 68 to dynamically generate 216 the updated control file 68, which is then returned to the requesting client platform 46.

If the request is not a request for an updated control file 68, the request is checked 220 to determine if the request is a valid request for some content held or managed by the content server 62. A valid request for managed content results in the content being selected or, as appropriate, generated 222 and returned 224 to the requesting client platform 46.

If the request is to provide feedback information from the cache control system 56, the request is first reviewed for validity 226, preferably to ensure that the information to be provided is from a known client platform 46. The information provided in connection with a valid feedback request is then parsed 228 by the feedback and use recording server 74 and stored 230 to the activity repository 76 for subsequent reference, preferably with regard to the generation 216 of control files specific to the client platform 46 that originated the information and as an aggregated basis for influencing the generation 216 of updated control files in general.

Finally, invalid requests and requests for content or other resources outside of the managed scope of the control file and content servers 62, 68 are refused 232.

Thus, a system and methods providing for the reliable and continuous streaming of multimedia content on a client platform have been described. The provision and controlled, autonomous operation of a last-element cache on the client platform enables the content stored by the cache to be efficiently managed entirely between a remote cache content management site and the local cache control system. Thus, unlike conventional network infrastructure caches, no unmanaged content is stored by the last-element cache. Third-party incidentally content transferred through the shared network infrastructure between the remote content server systems and local cache control system has no effect on and does not impede the operation of the last-element cache. Rather, the last-element cache content is a unique and optimal selection of contents cooperatively determined predominately by operation of the remote content manager, though specifically influenced by the operation of the local cache control system.

Additionally, the utilization of control files as the basis for the distributed management of last-element cache contents enables each last-element cache to be proactively filled with content with a very high likelihood of actual request and use by the end-user. The use of control files in this manner also allows the client platform to pull content from disparate remote content server sites, ensure that only specific and centrally authorized content is retrieved, yet optionally enable the remote cache content management system to appear to operate as a content push system, analogous to a radio program broadcaster.

The effectively centralized generation of control files, coupled with the intelligent parsing of the control files by the local cache control system further enables comprehensive management of the rather substantial content retrieval load generated by a significant number of client platforms. The generated control files are used to strategically distribute the content distribution load temporally over all available content servers, thereby minimizing the peaking of content retrieval demands and enabling full utilization of the availability and performance of the distributed remote content servers.

Finally, while the present invention has been described generally with reference to establishing a last-element cache system to support channel delivery of multimedia content analogous to a radio broadcast, the present invention is equally useful in any applications that would benefit from the availability of secure, distributed content caches whose content is uniquely and optimally managed by a centralized server system in combination with the individual client platforms.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A last-element cache system provided on a network connected client computer system, said last-element cache system comprising:
a) a cache store providing for storage of streaming content on a client computer system;
b) a streaming content player executable by said client computer system; and
c) a cache control system, executable by said client computer system, coupled to transfer on-demand streaming content from said cache store to said streaming content player.

2. The last-element cache system of claim 1 wherein said cache control system includes a network proxy and wherein said cache control system provides for network requests by said streaming content player to be routed through said network proxy, said cache control system providing for the selective satisfaction of predetermined network requests from said cache store.

3. The last-element cache system of claim 2 wherein said client computer system implements a digital rights management system and wherein said cache control system is coupled to interface with said digital rights management system, and wherein access to the contents of said cache store by said cache control system is constrained to accesses permitted through the operation of said digital rights management system.

4. The last-element cache system of claim 3 wherein said cache control system provides for the transfer of predetermined streaming content from said cache store in response to said predetermined network requests and wherein access to said predetermined streaming content by said streaming content player is constrained to accesses permitted through the operation of said digital rights management system.

5. A network system supporting the streaming of multimedia content provided from a server system through a network connection to a content player executed by a client system, said network system comprising:
a) a last-element cache provided as the terminal element of a distributed network cache system, said last-element cache residing within a persistent data store of a client system; and
b) a cache content controller coupled to said last-element cache, wherein said cache content controller operates as the exclusive local access manager for the content of said last-element cache, said cache content controller being responsive to a remote content server system to select a plurality of predetermined content files for storage by said last-element cache and responsive to said content player for selecting a predetermined one of said predetermined content files for transfer to said content player.

6. The network system of claim 5 wherein said cache content controller receives a control file from said remote content server system through a communications network, wherein said control file identifies said plurality of predetermined content files, and wherein said cache content controller receives said plurality of predetermined content files via said communications network.

7. The network system of claim 6 wherein said cache content controller operates autonomously in evaluating said control file and in retrieving said plurality of predetermined content files.

8. The network system of claim 7 wherein said cache content controller includes a rules evaluation engine and wherein parameters of the autonomous operation of said cache content controller are established through the evaluation of rules by said rules evaluation engine.

9. A cache management system enabling centrally controlled management of the contents of a cache provided to ensure reliably continuous streaming transfer of multimedia content to a content player executed on a client computer system, said cache management system comprising:
a) a last-element cache deployed local to a client computer system; and
b) a cache control program executed by said client computer system and coupleable to said last-element cache such that the contents of said last-element cache are accessible exclusively through said cache control program subject to a cache management policy autonomously implemented by said cache control program, wherein said cache control program provides for the evaluation of a control file obtained by said cache management system to identify and initiate retrieval of a predetermined set of content files from a remote content server through a communications network.

10. The cache management system of claim 9 wherein said last-element cache is maintained encrypted.

11. The cache management system of claim 10 wherein said cache control program includes an interface to a digital rights management system and wherein said cache control program is licensable through said digital rights management system to enable access to said last-element cache.

12. The cache management system of claim 9 or 11 wherein said cache control program implements a network proxy interface to an external communications network and wherein said cache control program provides for the selective transfer of said predetermined set of content files to said content player in response to the detection of a predetermined request by said content player.

13. The cache management system of claim 12 wherein said cache control program includes a player interface coupleable to said content player to receive said predetermined request and wherein said cache control program supports the sequential streaming transfer of said predetermined set of content files to said content player in a predetermined order based on said control file.

14. A method of ensuring reliably continuous streaming of network provided multimedia content sourced from a remote content server system to a content player executed by a client computer system, said method comprising the steps of:
a) autonomously determining, by a control program executed on a client computer system, a set of content files to be streamed to a content player;
b) autonomously retrieving said set of content files into a last-element cache local to said client computer system; and
c) autonomously responding to a predetermined request for streaming content from said content player to stream said content files to said content player.

15. The method of claim 14 further comprising the step of autonomously obtaining a control file from a control file server remotely through a communications network, wherein said control file includes a plurality of directives, and wherein said step of autonomously determining is performed based on a specification of said set of content files provided by said plurality of directives.

16. The method of claim 15 wherein said step of autonomously retrieving is performed independent of said predetermined request.

17. The method of claim 16 wherein said step of autonomously responding includes autonomously evaluating said plurality of directives to develop an active playlist defining an order with which to stream said set of content files to said content player.

18. The method of claim 17 wherein further comprising the step of receiving feedback information from an end-user of said content player and wherein said step of autonomously evaluating includes evaluating said feedback information.

19. The method of claim 18 further comprising the steps of:
a) autonomously transferring, by said control program, said feedback information to said control file server; and
b) autonomously generating, by said control file server, said control file based on said feedback information.

20. The method of claim 19 wherein said step of autonomously retrieving includes the step of encrypting and decrypting said set of content files as transferred into and out of said last-element cache such that said last-element cache is maintained as an encrypted object.
